(19) United States
(12) Patent Application Publication
(10) Pub. No.: US 2010/0076987 A1
(43) Pub. Date: Mar. 25, 2010

(54) Trust Profile Aggregation from Various Trust Record Sources

(76) Inventor: Benjamin Schreiner, Santa Clara, CA (US)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 12/208,047

(22) Filed: Sep. 10, 2008

(51) Int. Cl. G06F 17/30

(52) U.S. Cl. 707/754; 707/E17.044

(57) ABSTRACT

Trust-based relationships may be formed among many types of entities, and such entities may wish to rely on such relationships as part of a trust profile in future endeavors. However, it may be difficult to compile records of existing trust-based relationships into a trust profile in a credible and efficient manner. Techniques may be developed for centralizing the formation and management of a trust profile for the entity in an efficient manner that both promotes the integrity of the compiled information and extends to the entity a measure of control over the contents of the trust profile.

### BACKGROUND

Trust has long been valued as evidence of character and reliability of an entity, such as an individual, an organization, a company, or a government. The trust record is compiled from past actions and behaviors of a positive, negative, neutral, and/or indeterminate nature, which together comprise a record of the entity's past actions that may serve as a predictor of reliability in future interactions. Many types of trust information are available, based on different sources of information; e.g., a commercial trust record may be established by the reliability of the user in commercial transactions, while a personal trust record may be established by the involvement of the user in a community group, such as a volunteering organization.

Many types of trust information may be available through various agencies. For example, a commercial transaction site may report the user's reliability as a set of feedback ratings from various commercial partners who have transacted with the user; a community group may provide metrics, such as hours of volunteerism donated to the organization; and a hobbyist group may provide an anecdotal narrative written by associates illustrating the trustworthiness of the user. Some of these agencies often maintain a tight degree of control over data acquisition, aggregation, and reporting in the interests of consistency, security, and privacy.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Although many types of trust record information may be available regarding an entity (such as an individual, an organization, a company, or a government), the uses of such information may be limited in several aspects. As a first example, many sources of trustworthiness information may be stored only in an informal manner (e.g., by contacting an organization to request information about a member), and may be unavailable in a standardized form. As a second example, the trust information gathered by each collecting agency may be of a very specific type, and may be limited to a particular role or use; e.g., a commercial agency may only indicate the reliability of the user in completing commercial transactions, and a hobbyist organization may only be cognizant of the user's reliability in social situations. As a third example, compiling a detailed record of the entity's trust profile may involve a lengthy and complicated solicitation of information from a large and varied set of sources of trust information. As a fourth example, the entity may have little or no control over which sources of information may contribute to the trust record of the entity; e.g., an individual may have very little control over the contents of his or her commercial transaction record, and may be deterred or prevented from disputing, correcting, and responding to misrepresentations, contextually skewed information, and out-of-date information.

Due to these and other factors, it may be difficult to examine and summarize an individual's trust record based on many types of trust information. When an entity joins a new community, such as an individual subscribing as a member of a website, the entity may be unable to present or rely upon a positive trust record that the entity may have earned through positive transactions with various other types of communities. Instead, the entity may have to begin building a new trust profile within the new community, and other members of the community may be unable to ascertain the trustworthiness and reliability of the entity as a new community member without the benefit of referencing sources of previously compiled trust information.

These limitations of trust profiling may be ameliorated through the development of a trust profiling organization, which may utilize various techniques to retrieve, compile, and present a profile of the trustworthiness of an entity. The trust reporting may begin with the creation of a trust profile for the entity, which may be initiated (e.g.) upon request of the entity. The trust profile of the entity may be filled with trustworthiness information received from trust record sources, which may be named by the entity as independent sources of trust information. For example, the entity may provide a list of trust record sources that may contribute to the entity's trust profile, and the trust profiling organization may contact each trust record source to request a trust profile of the entity. The collected information may be stored to represent the entity's trustworthiness, and may be supplemented, updated, maintained, and/or reported to various trust reporting agencies in order to evidence the trustworthiness of the entity.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario illustrating a compiling and representing of a trust profile of an entity.

FIG. 2 is an illustration of another exemplary scenario illustrating a compiling and representing of a trust profile of an entity.

FIG. 3A is an illustration of an exemplary interaction involved in the representing of a trust profile of an entity.

FIG. 3B is an illustration of another exemplary interaction involved in the representing of a trust profile of an entity.

FIG. 3C is an illustration of still another exemplary interaction involved in the representing of a trust profile of an entity.

FIG. 3D is an illustration of still another exemplary interaction involved in the representing of a trust profile of an entity.

FIG. 4 is an illustration of still another exemplary scenario illustrating a compiling and representing of a trust profile of an entity.

FIG. 5 is a flow chart illustrating an exemplary method of representing the trust profile of an entity.

FIG. 6 is a flow chart illustrating another exemplary method of representing the trust profile of an entity.

FIG. 7 is a component block diagram illustrating an exemplary system for representing the trust profile of an entity.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The actions of an entity (such as an individual, an organization, a company, or a government) may result in a set of information that represents the trustworthiness of the entity. This set of trust information may include observations by others who interact with the entity. For example, an individual's trustworthiness may involve observations of the individual by the individual's school teachers and professors, employers and colleagues, lenders, and commercial partners, and may relate to the individual's trustworthiness, reliability, capabilities, assets, liabilities, etc. This trust information may be highly valued as a predictor of the entity's future behavior; e.g., a company with a good credit review is likely to service a current or future loan better than a company with a bad credit review. Accordingly, current and future associates of the entity (such as commercial partners, employers, and financial institutions) may wish to evaluate the trustworthiness of the entity before deciding on the extent of a potential interaction with the entity. This evaluation may benefit an entity that has compiled a more favorable trust profile, and may provide notice of caution while interacting with an entity that has compiled a less favorable trust profile (e.g., a financial institution may wish to secure a greater amount of collateral before lending to an entity with an unfavorable credit score.)

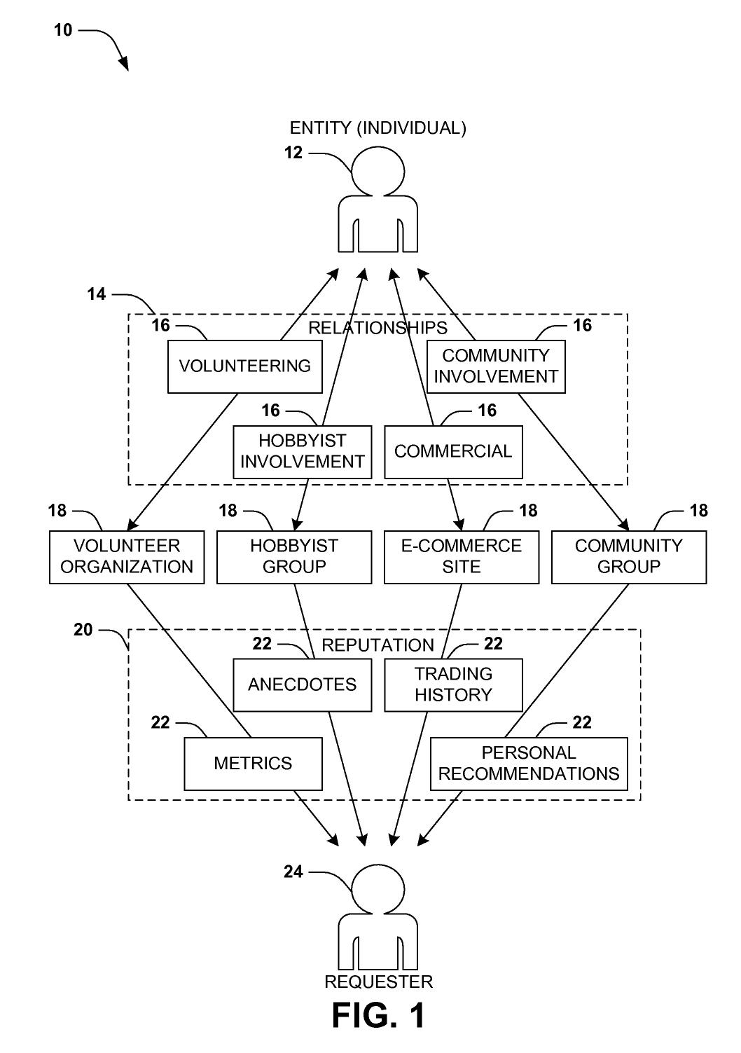

FIG. 1 illustrates an exemplary scenario 10 involving an entity 12 (in this scenario, an individual) who has cultivated a relationship set 14 comprising relationships 16 with various sources. For example, the individual may have developed a leadership relationship with a volunteer organization, a hobbyist group, a community group, an employment relationship with an employer, and an e-commerce site, all of which have built relationships with the individual and may be able to attest to the trustworthiness of the individual. A second party may wish to evaluate certain aspects of the trustworthiness of the entity 12, and the entity 12 may consent to such evaluation; for example, the individual may apply for a position with a new employer, who wishes to review the trustworthiness of the individual before hiring him or her as an employee. The entity 12 and the second party may therefore cooperate to complete an evaluation of the trustworthiness of the employee, and the second party may seek evidence of the individual's trustworthiness from the parties with whom the entity 12 has cultivated relationships. Accordingly, the second party (as a requester 24) may request information from each related party (as a trust record source 18), each of which may provide a trust profile 22 to the requester 24 (pending the consent of the entity 12.) The trust profiles 22 may collectively comprise a representation of the trust profile 20 of the entity 12, which may be provided for evaluation to the requester 24 as evidence of the conduct of the entity 12 in past transactions.

However, as further illustrated in the scenario 10 of FIG. 1, this evaluation may not be a simple matter. As a first example, and in many scenarios, the requester 24 may have to initiate contact and file a request with each trust record source 18, which may be complicated and time-consuming. Moreover, each trust record source 18 may have a different protocol for requesting and providing trust profiles 22; e.g., a first trust record source 18 may provide a website for requesting and viewing such information, while a second trust record source 18 may handle requests via email, and a third trust record source 18 may only provide information during an in-person meeting. As a second example, each trust record source 18 may provide a different type of trust profile 22, and it may be difficult to aggregate the trust profiles 22 in a fair, consistent, and objective manner. Even trust profiles 22 of a similar nature may be differently specified; e.g., e-commerce sites may develop different metrics for the trust profile and rating of the entity 18. As a result, different requesters 24 may differently weigh the comparative merits of an employment relationship and an academic relationship, leading to potentially inconsistent and subjective evaluations. As a third example, a trust profile 22 may be prepared in view of a specific perspective or use, and may exclude information that is not consistent with that perspective or use but that may be relevant to the requester 24. For example, a volunteer organization may prepare a trust profile 22 indicating the number of hours of service, but may not identify the types of service provided or personal anecdotes that support the assertion of trustworthiness.

Several disadvantages arise from these difficulties. As a first example, it may be difficult or prohibitive for a requester 24 to prepare and review a trust profile for an entity 12. Such information may also be incomplete, inconsistent, contradictory, or out-of-date. Because of the informal nature of the requesting and reporting processes, an entity 12 may have difficulty securing the privacy of its trust profile; e.g., trust record sources 18 may be unable to contact the entity 12 or verify that a particular request for trust information is made with the consent of the entity 12. An entity 12 may also have difficulty addressing the contents of its trust profile, and may be deterred or prevented from correcting misinformation or selecting particular trust record sources 18 for reporting (e.g., an entity 12 may have difficulty preventing a potential employer from contacting a current employer, which may result in an unfairly negative reference and/or a loss of the current employment.)

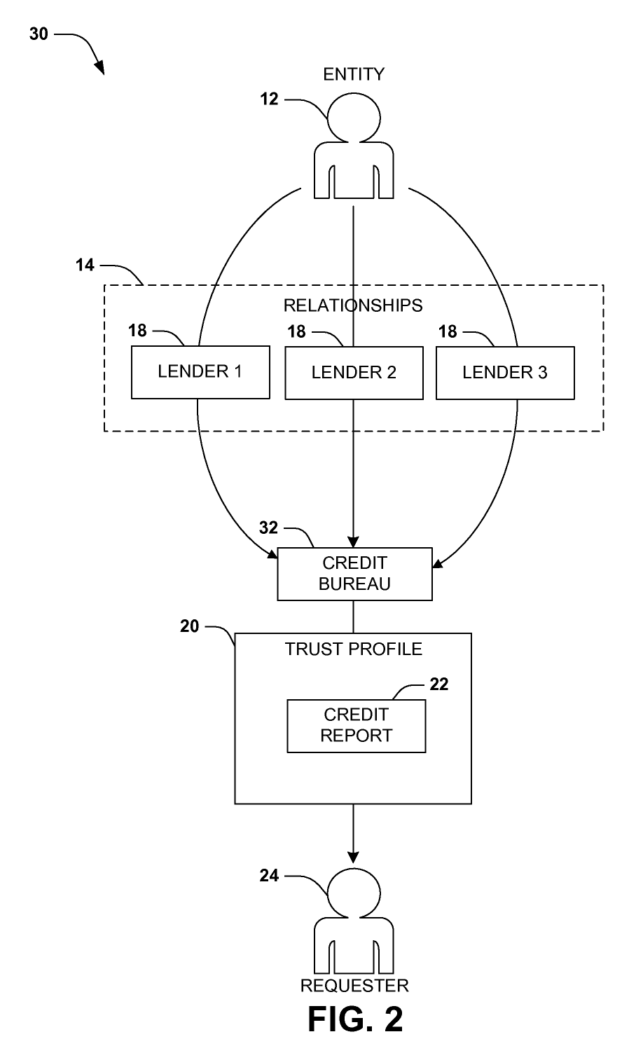

FIG. 2 illustrates another scenario 30 wherein a trust profile 20 of an entity 12 may be represented by a central trust reporting agency in the form of a credit bureau 32. The credit bureau 32 arranges to collect financial information from various lenders (serving as trust record sources 18) who have previously transacted with the entity 12. The entity 12 grants consent to such monitoring by the credit bureau 32 as a condition of receiving loans from the respective lenders. The credit bureau 32 thereby maintains a credit history for the entity 12, and may disclose this information to qualified requesters 24 (subject to certain qualifications, including a consent by the entity 12 for such requester 24 to access the credit report managed by the credit bureau 32.) In this manner, the credit bureau 32 thereby represents the trust profile 20 of the entity 12 as a trust profile 22 in the form of a credit score and credit history.

The exemplary scenario 30 of FIG. 2 has some advantages over the exemplary scenario 10 of FIG. 1. As a first example, the requester 24 may obtain a trust profile 22 from a reliable centralized agency through well-established procedures. As a second example, the reported information may be more easily normalized and evaluated in a more objective manner, e.g., with reference to information about credit score standards. As a third example, because the set of information periodically reported by each lender is constrained to a small set of factual information (e.g., the status of an account, the credit limit and periodic total, and the reliability of the entity 12 in servicing the debt), the collection of information by the credit bureau may be readily automated for easier, more accurate, and continuously up-to-date processing. As a fourth example, legal regulations placed on credit bureaus may facilitate the entity 12 in correcting information that is out of date or is incorrectly reported by various lenders.

However, the exemplary scenario 30 of FIG. 2 also presents some disadvantages. As a first example, the entity 12 has very little control over the contents of the trust profile 22, since all lenders regularly report to the credit bureau, which synthesizes all of the information to generate the trust profile 22. The involvement of the entity 12 is limited to correcting inaccuracies, such as the address or the amount of a loan. As a second example, the information reported by the credit bureau is very specific to the credit history of the entity 12, and usually does not even include related financial information, such as income, owned assets, and receivables owned by the entity 12, all of which may be relevant to the requester 24 in many types of assessments involving an evaluation of a credit history (e.g., whether to issue a new loan.) As a third example, the trust profile 22 has little or no capacity for non-financial information, such as employment status or academic credentials, and therefore may be useful only for a narrow range of inquiries.

The exemplary scenario 10 of FIG. 1 and the exemplary scenario 30 of FIG. 2 therefore illustrate some disadvantages with various techniques for collecting, compiling, and reporting the trust profile 20 of an entity 12. An improved technique may be devised for representing the trust profile 20 of an entity 12 that balances the range of information that may be contained in the trust profile 20 and an improved degree of control by the entity 12 over the contents of the trust profile 22 against the convenience of centralized report collection (such as by a credit bureau) and the improved accuracy and freshness of automated information gathering. The application of such techniques may enable the development of a trust reporting service that is both appreciated by entities 12 as a fair and responsive service, while also providing authorized requesters 24 with a convenient source of broad, accurate information about the trust profile 20 of the entity 12.

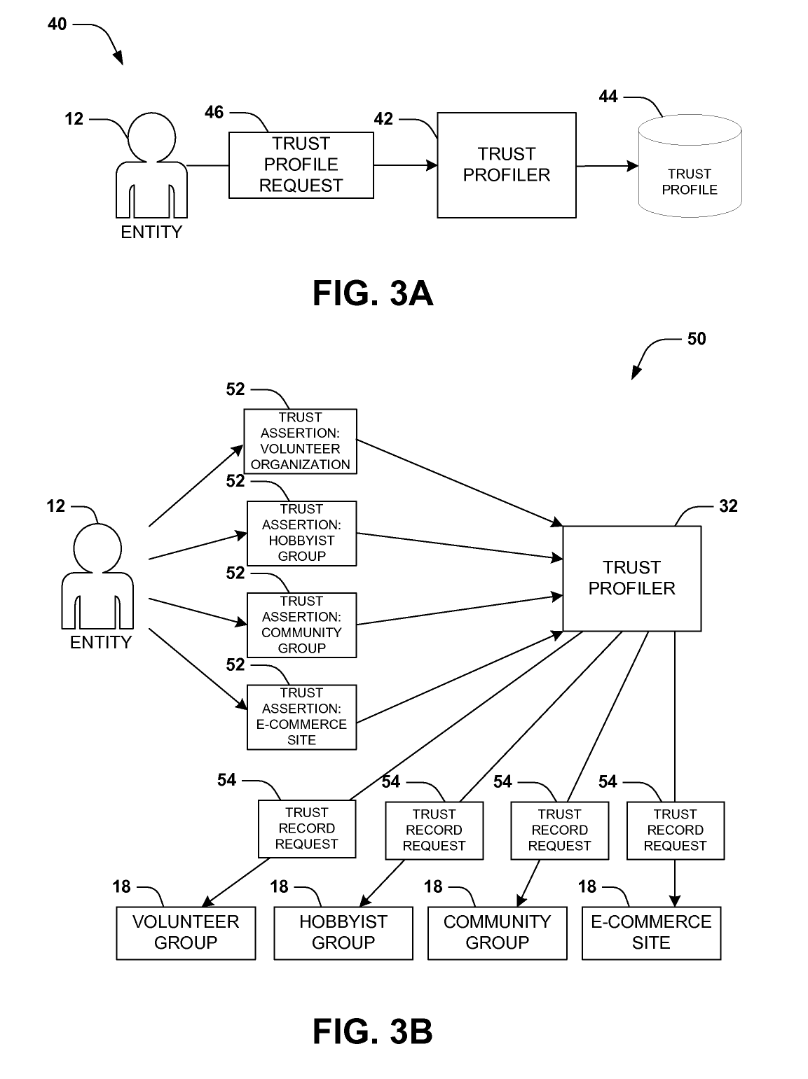

FIGS. 3A-3D together illustrate one such technique for representing the trust profile 20 of an entity 12, wherein the information is gathered by a trust profiler 32 that cooperatively interacts with the entity 12, trust record sources 18, and requesters 24. The technique presented herein involves four basic interactions among these parties, illustrated in turn in FIGS. 3A-3D.

In the exemplary interaction 40 of FIG. 3A, the entity 12 may initiate the creation of a trust profile 44, which comprises the set of trust information reported by various parties who have interacted with the entity 12. The entity 12 may therefore send to the trust profiler 42 a request 46 to create a new trust profile 44 for the entity 12. The trust profiler 42 may respond by creating a new trust profile 44, which may initially be empty (i.e., may contain only some basic identity and demographic information about the entity 12.)

In the exemplary interaction 50 of FIG. 3B, the entity 12 may wish to fill its trust profile 44 with trust information. The entity 12 may therefore send the trust profiler 32 a set of relationship assertions 52, each asserting that the entity 12 has established some type of relationship with a particular trust record source 18. For example, the entity 12 may indicate that trust information may be available and reported by (e.g.) a volunteer organization, a hobbyist group, a community group, and an e-commerce site. The trust profiler 32 may therefore initiate contact with each trust record source 18, and may send a trust record request 54 to each trust record source 18, which requests any information that the trust record source 18 may provide regarding the trust profile 20 of the entity 12. The trust profiler 32 may not add any information to the trust profile 44 of the entity 12 until relevant information arrives from the trust record sources 18.

In the exemplary interaction 60 of FIG. 3C, the trust profiler 32 may receive one or more trust records 62 from the various trust record sources 18. Such information may be as limited as the acknowledgment of a relationship 16 between the trust record source 18 and the entity 12, as specific as a detailed account of the activities of the entity 12 with the trust record source 18 (e.g., an e-commerce site may report a complete list of transactions and detailed feedback from each transaction party who has interacted with the entity 12), or an intermediate level of detail (e.g., a summary set of feedback ratings, or even a single rating, indicating the overall reliability of the entity 12 in commercial transactions.) The trust profiler 32 may receive and store these trust records 62 in the trust profile 34 of the entity 12.

In the exemplary interaction 70 of FIG. 3D, the trust profiler 32 may receive a trust profile request 72 from a requester 24 that solicits some information about the trust profile 20 of the entity 12. The trust profiler 32 may therefore retrieve the trust profile 34 of the entity 12, and may prepare and send to the requester 24 a trust profile 22 that details the complete set (or a portion thereof) of trust information received from the trust record sources 18.

The interactions illustrated in FIGS. 3A-3D therefore present an alternative technique for compiling a trust profile 20 of an entity 12 and generating a trust profile 22 based on the information received from a variety of trust record sources 18. In comparison with the decentralized exemplary scenario 10 of FIG. 1 and the tightly centralized exemplary scenario 30 of FIG. 2, this alternative technique results in a trust profile comprising many types of trust information derived from many types of sources, and also permits the entity 12 greater control over the sources consulted for such information.

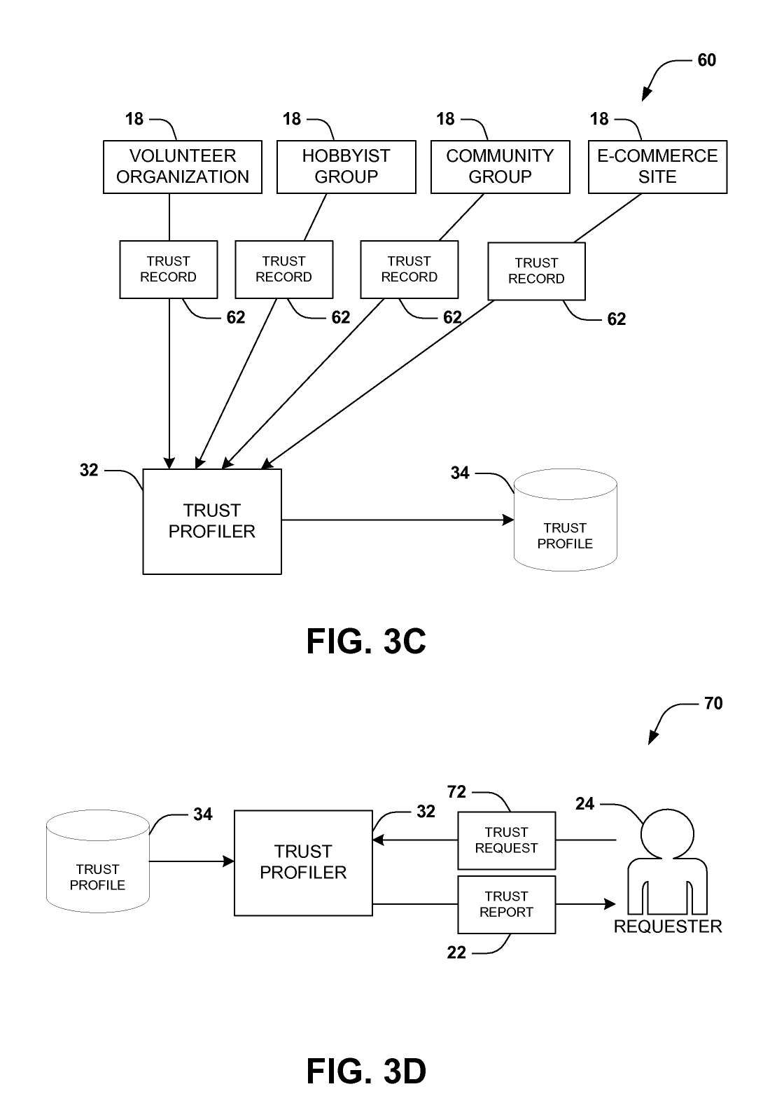

FIG. 4 illustrates an exemplary scenario 80 featuring a trust profile 22 generated in this manner. As in the exemplary interactions of FIGS. 3A-3D, the trust profiler 32 receives an initial request from the entity 12 to generate the trust profile 34, and subsequently fills the trust profile 34 with trust records 62 provided by respective trust record sources 18 upon request by the entity 12. When the trust profile 22 of the entity 12 is subsequently requested by an authorized requester 24, the trust profiler 32 may then use the trust records 62 in the trust profile 34 to prepare a trust profile 22 as a set of trust records 62. For example, each trust record 62 may specify the trust record source 18, a relationship descriptor 82 that describes the relationship 16 between the entity 12 and the respective trust record source 18 (e.g., a relationship type descriptor that specifies, e.g., a volunteering relationship with a volunteer organization, a member relationship with a hobbyist group and a community group, and a seller relationship with an e-commerce site), and a relationship rating 84 that indicates the quality of the relationship as reported by the respective relationship source (e.g., volunteerism metrics reported by the volunteerism group, trustworthiness-related anecdotes reported by a community group, and a seller feedback rating earned through the e-commerce site.) The trust profile 22, compiled in this manner with cooperative control shared among the entity 12, the trust record sources 18, and the trust profiler 32, may then be provided to the requester 24 as evidence of the trust profile 20 of the entity 12.

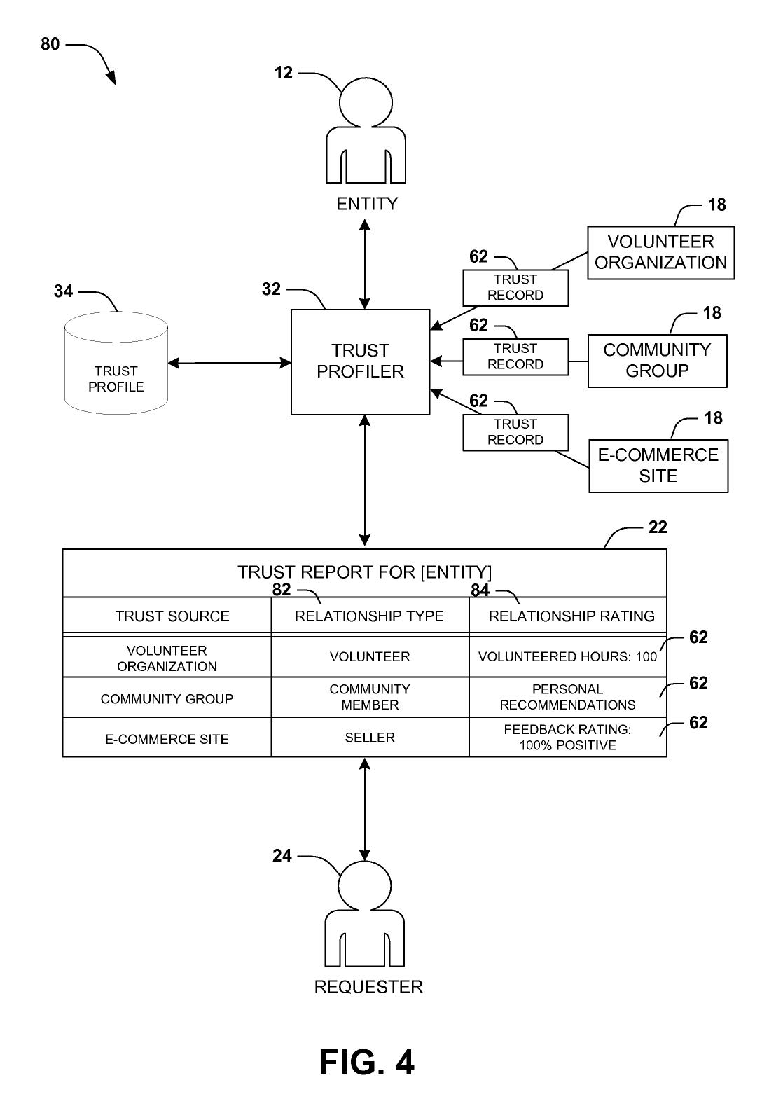

FIG. 5 illustrates a first embodiment of these techniques, comprising an exemplary method 90 of representing the trustworthiness of an entity, in accordance with the techniques illustrated in the exemplary interactions of FIGS. 3A-3D. The exemplary method 90 begins at 92 and involves generating 94 a trust profile upon receiving from the entity a request to generate a trust profile (such as illustrated in FIG. 3A.) The exemplary method 90 also involves requesting 96 a trust record of the entity from a trust record source upon receiving from the entity a relationship assertion specifying the trust record source (such as illustrated in FIG. 3B.) The exemplary method 90 also involves storing 98 trust records in the trust profile of the entity receiving such trust records from the trust record sources (such as illustrated in FIG. 3C.) The exemplary method 90 also involves providing 100 the trust profile upon receiving a request for the trust profile of the entity (such as illustrated in FIG. 3D.) Having compiled the trust profile in a cooperative manner with both the entity and the trust record sources, and having provided a representation of the trust profile upon request, the exemplary method 90 thereby achieves the representing of the trustworthiness of the entity in accordance with the techniques discussed herein, and so ends at 102.

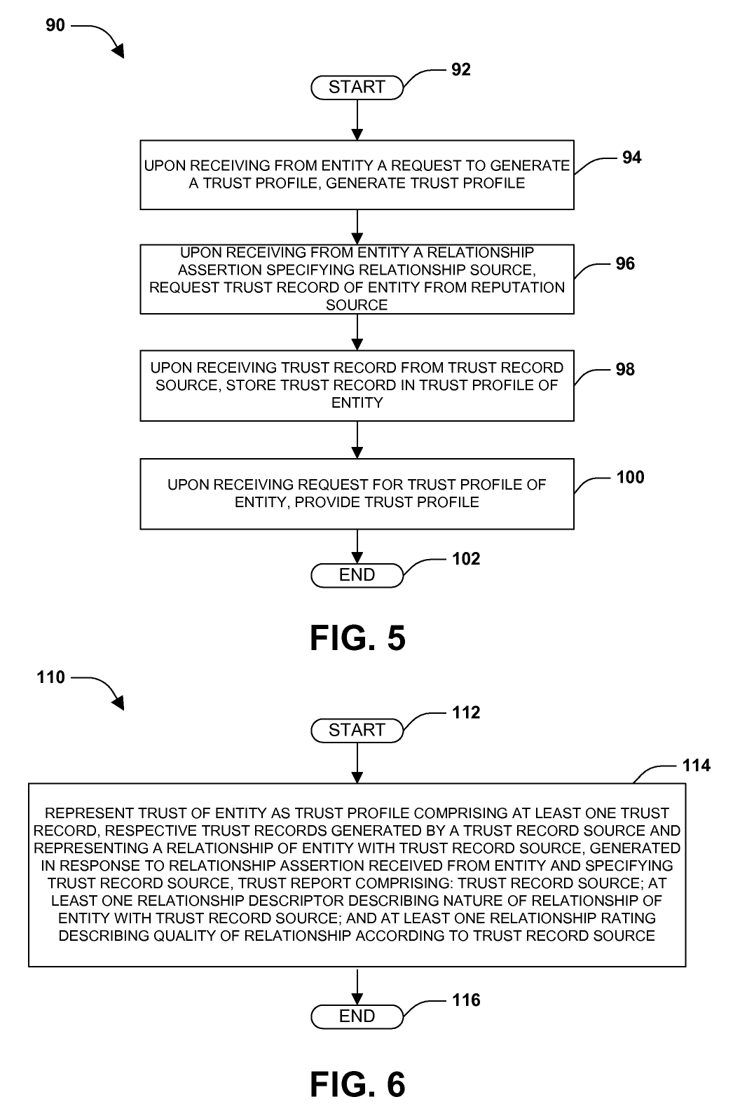

FIG. 6 illustrates a second embodiment of the techniques discussed herein, also represented as an exemplary method 110 of representing the trustworthiness of an entity, in accordance with the technique illustrated in FIG. 4. The exemplary method 110 begins at 112 and involves representing 114 the trustworthiness of the entity as a trust profile comprising at least one trust record, where such trust records are generated by a trust record source and representing a relationship of the entity with the trust record source, and are generated in response to a relationship assertion received from the entity and specifying the trust record source. The respective trust records represented by this exemplary method 110 therefore comprise the trust record source, at least one relationship descriptor describing the nature of the relationship of the entity with the relationship source, and at least one relationship rating describing the quality of the relationship according to the relationship source. By providing the trust profile comprising trust records containing such information and generated by the trust record sources at the request of the entity, the exemplary method 110 thereby achieves the representing of the trustworthiness of the entity in accordance with the techniques discussed herein, and so ends at 116.

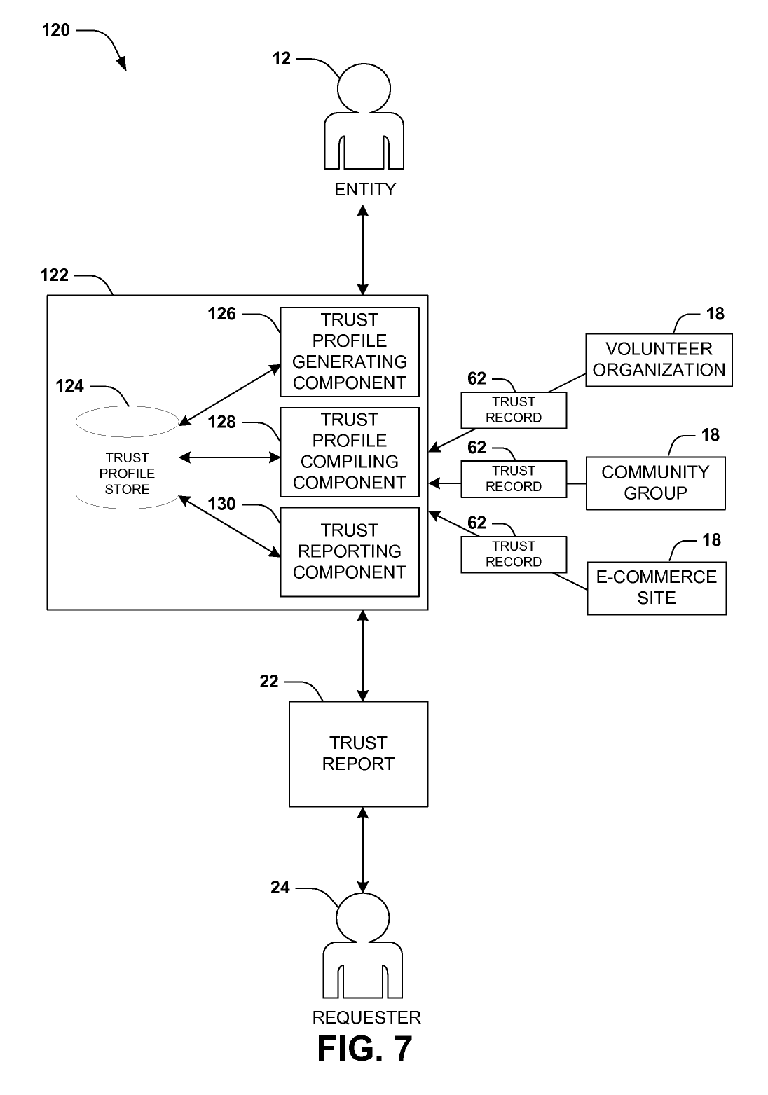

FIG. 7 illustrates an exemplary scenario 120 featuring a third embodiment of the techniques discussed herein, comprising an exemplary system 122 for representing the trustworthiness of an entity 12. The exemplary system 122 cooperatively interacts with the entity 12 and a set of trust record sources 18 that may provide trust information to be synthesized into the represented trustworthiness of the entity 12, and may be provided, e.g., to a requester 24 who seeks information as to the trustworthiness of the entity 12. The exemplary system 122 comprises a trust profile store 124, which is configured to store trust records 62 comprising a trust profile of the entity 12. The exemplary system 122 also includes a trust profile generating component 126, which is configured, upon receiving from the entity 12 a request to generate the trust profile, to generate the trust profile in the trust profile store 124. The exemplary system 122 also comprises a trust profile compiling component 128, which is configured, upon receiving from the entity 12 a relationship assertion specifying a trust record source 18, to request a trust record 62 of the entity 12 from the trust record source 18. The trust profile compiling component 128 is also configured, upon receiving the trust record 62 from a trust record source 18, to store the trust record 62 with the trust profile of the entity 12 in the trust profile store 124. The exemplary system 122 also includes a trust reporting component 130, which is configured, upon receiving a request for the trust profile of the entity 12, to provide the trust profile, e.g., in the form of a trust profile 22 such as the exemplary trust profile 22 illustrated in FIG. 4. The interoperating components of this exemplary system 122 thereby achieve the compiling of a trust profile of the entity 12 from the information provided by the trust record sources 18 and the reporting of the trust profile of the entity 12 upon request.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 90 of FIG. 5, the exemplary method 110 of FIG. 6, and the exemplary system 122 of FIG. 7) to confer individual and/or synergistic advantages upon such embodiments.

A first aspect that may vary among embodiments of these techniques relates to the types of relationships and trust record sources included in the trust profile and the trust profile generated therefrom. As a first example, the trust profile may include many types of relationship types with various trust record sources. For instance, a volunteer organization may provide trust information for an entity having one or more of several types of relationships with the organization: a volunteering relationship, an employee relationship, and a financial donor relationship, and each type of relationship may have different trustworthiness-describing metrics. In one such variation, the trust records may specify a relationship category between the entity and the trust record source; e.g., the relationship category may be chosen from a set of relationship types including a commercial relationship, a professional relationship, an academic relationship, a special interest relationship, a social network relationship, a community relationship, and a volunteer relationship.

As a second example of this first aspect, and in contrast with the exemplary scenarios of FIGS. 1 and 2, the trust profile may include a comparatively broad set of trust record sources that provide a more diverse set of trust information, thereby producing a more comprehensive portrayal of the entity. For instance, the trust record sources may include conventional sources of trust-based information, such as a credit bureau that provides trust profiles including a credit score as a trustworthiness rating. The trust record sources may also include less conventional sources of trust-based information, such as organizations with which the entity has a membership relationship. The organization may therefore serve as a trust record source by providing a trust profile describing the entity's activities in the organization and the quality of the relationship so established. For instance, the organization may comprise an internet-based community, such as a web forum to which the entity has belonged and has contributed, or an e-commerce site through which the entity has purchased and/or sold goods or services. Many types of relationships and trust record sources may therefore be compiled in the trust profile and included in the trust profile as part of the representation of the entity.

A second aspect that may vary among embodiments of these techniques relates to the organization of information in the trust records and the trust profile and the reporting of such information in a trust profile. As a first example, and as illustrated the exemplary scenario 80 of FIG. 4, a trust profile 62 may comprise the identity of the trust record source 18, one or more relationship descriptors 82 that describe the nature of the relationship 16 of the entity 12 with the relationship source 18, and one or more relationship ratings 84, which together bear on the trustworthiness of the entity 12.

As a further variation of this example, the trust record may contain a series of relationship descriptors that together describe the relationship of the entity with the trust record source. For instance, a first relationship descriptor may relate the duration of the relationship; a second relationship descriptor may relate the contribution of the entity to the relationship (e.g., a ranking of trading success and reliability attained by a seller through an e-commerce site, or a qualitative measure of participation of the entity in a community); a third relationship descriptor may relate to one or more transactions taken by the entity within the relationship (e.g., one or more trades made through an e-commerce site); and a fourth relationship descriptor may relate to one or more activities performed by the entity that do not directly relate to the primary nature of the relationship, but that are relevant to the relationship and indicative of the trustworthiness of the entity (e.g., extracurricular activity participation by a student; testing, reviewing, and/or dispute adjudicating participation by a trading member of an e-commerce site; or side projects completed by an employee.) In a still further variation of this example, the relationship ratings may relate to respective relationship descriptors; e.g., each relationship descriptor may have an associated relationship rating, and together these relationship ratings may indicate the composite quality of the relationship. For example, a credit score (as a qualitative measure of the financial trustworthiness of a user with a particular lender or credit bureau) is often obtained by considering several factors for each trust record (respectively representing accounts representing loans or lines of credit), such as the maximum amount of the account, the principle debt in the account, the age of the account, and the regularity of the servicing of the debt by the entity. Each such factor may comprise a relationship descriptor of a relationship record representing an account, and each relationship descriptor may be separately rated by a relationship rating to indicate the quality of the relationship of the entity with the creditor as a trust record source.

A second example of this second aspect, the trust profile and trust records may aggregate some elements for easier computation or evaluation. In a first such variation, a trust record may comprise at least one aggregated relationship rating associated with a trust record and describing the quality of the relationship according to the trust record source. For instance, where a trust record represents a debt or line of credit having several relationship ratings for various aspects of the account (e.g., a first relationship rating for the amount of the account, a second relationship rating for the age of the account, and a third relationship rating for the reliability of servicing), the trust record may contain an aggregated score that represents the net impact of the account on the financial trustworthiness of the entity. In a second such variation, the trust profile may comprise at least one aggregated relationship rating associated with at least two trust records and describing the quality of at least two relationships of the entity with at least two trust record sources. For example, the trust profile may contain an aggregated trust rating for the overall trustworthiness of the entity based on all of the trust records, or may contain a series of trust ratings respectively based on particular types of trust records (e.g., an academic trust rating for the academic trustworthiness of the entity based on the trust records of an academic relationship type; a financial trust rating for the financial trustworthiness of the entity based on the trust records of a financial relationship type; etc.) Such aggregated ratings may be precomputed and stored in the trust profile, or may be computed from the information in the trust profile while generating the trust record. The aggregation of such relationship ratings and other elements may facilitate the evaluation of the trustworthiness of the entity by various requesters, and may promote consistency of evaluation among requesters. Those of ordinary skill in the art may devise many organizations and contents of trust profiles and trust profiles while implementing the techniques discussed herein.

A third aspect that may vary among implementations of these techniques relates to the manner of compiling and reporting the trust profile, which may supplement or extend the exemplary interactions illustrated in FIGS. 3A-3D. A first example relates to the manner in which an entity 12 may specify a relationship assertion 52 with a particular trust record source 18. In one such embodiment, the trust profiler 32 may simply act on any trust record source 18 specified by the entity 12, and may seek to verify the relationship and obtain a trust profile from the specified trust record source 18. For instance, the trust record request 54 may simply comprise an email message sent to the trust record source 18 and requesting the completion of a web form that comprises the trust record 62. In another such embodiment, the trust profiler 32 may compile a trust record source dataset, which contains details about known trust record sources. For example, the trust profiler 32 may then offer the names of trust record sources 18 stored in the trust record source dataset to the entity 12 for selection, or may simply compare the names of specified trust record sources 18 specified by the entity 12 with the names of trust record sources 18 stored in the trust record source dataset. The trust profiler 32 may therefore process the relationship assertion 52 by searching the trust record source dataset for the specified trust record source, and may use the information in the dataset to interact with the trust record source. In a further variation of this first example, the trust record source dataset may associate with each trust record source a trust record requesting protocol, whereby the trust profiler 32 may correctly file a trust record request 54 with the trust record source 18. For example, a first trust record source 18 may handle trust record requests 54 received through a web form or web service available at a particular URL, while a second trust record source 18 may handle trust record requests 54 through the completion and delivery by fax or mail of a paper document, and a third trust record source 18 may handle trust record requests 54 only through an in-person meeting or via email. The trust profiler 32 may therefore utilize the trust record requesting protocol associated with the trust record source in the trust record source dataset to act on the relationship assertion 52 received from the entity 12.

As another variation of this example, the trust profiler 32 may maintain the trust record source dataset by adding new trust record sources 18 that are specified by an entity but that are not yet known to the trust profiler 32. Such maintenance may be valuable, e.g., where the trust record sources may include web-based communities, which tend to be prolific and widely distributed, and are therefore not easily tracked in a comprehensive trust record source dataset. In this variation, upon failing to find a trust record source in the trust record source dataset that is specified by an entity 12 in a relationship assertion 52, the trust profiler 32 may contact the new trust record source 18 to identify or request from the trust record source 18 a trust record requesting protocol. Upon receiving or identifying such a protocol, the trust profiler 32 may store in the trust record source dataset both the new trust record source 18 and the identified or received trust record requesting protocol, and may also use this information to submit a trust record request 54 to the trust record source 18 in response to the relationship assertion 52 of the entity 12.

In some scenarios, a particular trust record source 18 may not have developed a trust record requesting protocol, or may not be willing to provide trust records to the trust profiler 32. However, the trust profiler 32 may receive relationship assertions by a potentially large number of entities who have established relationships with the trust record source 18, and who wish to use the trust record source 18 as a source of trust information. In these scenarios, the trust record source 18 may therefore utilize the aggregate interest of the entities to solicit the trust record source 18 to cooperate in the trust profiling by developing a trust record requesting protocol. For example, the trust profiler 32 may devise a petition directed to the attention of the trust record source 18, and may permit the entities to ascribe to the petition.

In one such embodiment, upon failing to receive a trust record requesting protocol from the trust record source 18, the trust profiler 32 may generate a trust record source protocol petition, and may add the entity 12 to the trust record source protocol petition. Upon receiving a relationship assertion from at least one additional entity (i.e., from further entities who wish to use the trust record source 18 as a source of trust information), the additional entities may be added to the trust record source protocol petition. Finally, the trust profiler 32 may send the trust record requesting petition to the trust record source 18. In this manner, the trust profiler 32 may attempt to compel the cooperation of the trust record source 18 in the trust profiling scenario. Those of ordinary skill in the art may devise many ways of generating the trust record source dataset, and uses thereof, while implementing the techniques discussed herein.

A second example of this third aspect relates the manner of generating the trust profile. In one such variation, the trust profile may be generated for a particular requester 24, and the generating may take into account the nature of the requester. For instance, the requester 24 may be interested in only particular types of trust information, such as academic and professional, and the trust profile 22 may contain only those types of trust records 62. Alternatively or additionally, the requester 24 may only be authorized to access particular types of information (e.g., the requester 24 may be a potential employer who is permitted to view only academic and employment information, but may not view the portions of the trust profile 34 of the entity 12 relating to community activities or financial trustworthiness.) The trust profile 22 generated for such a requester 24 may therefore only comprise the viewable trust records, and/or viewable portions thereof, according to the viewing permissions of the requester 24. Those of ordinary skill in the art may devise many ways of generating trust profiles 22 for various requesters 24, and in view of various privacy and relevancy concerns of the entity 12, while implementing the techniques discussed herein.

A third example of this third aspect relates to the updating of the trust profile 34 of the entity 12, which may be performed in order to maintain the currency of the trust profile 20 of the entity 12. In one such variation, the trust profile 34 may associate an expiration date with various trust records 62, and may remove such trust records 62 after the expiration date. In another such variation, the trust profiler 32 may periodically request an updated trust record 62 from the trust record sources 18 for a particular entity 12, and may store the updated trust records 62 in the trust profile 34 of the entity 12 (replacing or supplementing the previously received trust records 62 from these trust record sources 18.) Those of ordinary skill in the art may devise many ways of updating the trust profile 34 of the entity 12 while implementing the techniques discussed herein.

A fourth example of this third aspect relates to the control of trust information by the entity 12 in the trust profile 34, which may be updated upon request of the entity 12. In one such variation, the entity 12 may be permitted to annotate or comment upon trust information, and the comments of the entity 12 may be included in the trust profile 34 and/or trust profiles 22 generated therefrom. In another such variation, upon receiving from the entity 12 a removal request of a trust record 62 from the trust profile 34 of the entity 12, the trust profiler 32 may remove the trust record 62 from the trust profile 34. This may be performed in order to promote the degree of control of the entity 12 over the contents of the trust profile 34, e.g., where such information is out of date, now incorrect, or simply no longer of interest to the entity 12 as part of the entity's trust profile 34. Certain conditions may be placed on the removal of such information; e.g., in one such variation, the entity 12 may only be permitted to remove a trust record 62 after one year of inclusion in the trust profile 34. Those of ordinary skill in the art may devise many techniques for allowing an entity 12 to update or remove information from the trust profile 34 while implementing the techniques discussed herein.

A fourth aspect that may vary among embodiments of these techniques relates to authentication issues. It may be appreciated that the compiling and reporting of a trust profile 34 of an entity 12 may raise many issues of privacy, authenticity, and identity, and many opportunities for abuse such as for unauthorized access to sensitive trust details, impersonation and identity theft, and falsification of information (e.g., falsely positive information inserted by the entity 12 in order to improve the trust profile 20 of the entity 12, and/or falsely negative information inserted by an adversary of the entity 12 in order to damage the trust profile 20 of the entity.) Accordingly, the various parties who are involved in the compiling of the trust profile may be authenticated in various ways to establish and verify the identities of such parties. As a first example, upon receiving a request to generate a trust profile 34 for an entity 12, the trust profiler 32 may authenticate that the request is made on behalf of the entity 12. For instance, the trust profiler 32 may request from the entity 12 at least one entity credential authenticating the identity of the entity 12 (e.g., a mother's maiden name or social security number), and upon receiving the at least one entity credential, may authenticate the identity of the entity 12 according to the at least one entity credential. As a second example, upon receiving a relationship assertion from the entity 12 specifying a trust record source 18, the trust profiler 32 may request from the entity 12 at least one relationship credential authenticating the relationship 16 of the entity 12 with the trust record source 18 (e.g., a username and password used by the entity 12 on a web-based community); and upon receiving the at least one relationship credential, the trust profiler 32 may authenticate the relationship of the entity 12 with the trust record source 18 according to the at least one relationship credential. As a third example, the trust profiler 32 may authenticate the identity and permissions of a requester 24 of a trust profile 22 before generating and providing the trust profile 22. For instance, upon receiving the trust profile request 72, the trust profiler 32 may request at least one requester credential authenticating the identity of the requester 24; and upon receiving the at least one requester credential from the requester 24, the trust profiler 32 may authenticate the identity of the requester 24 according to the at least one requester credential. Those of ordinary skill in the art may identify many occasions for authenticating the identities of parties involved in the trust profiling and reporting while implementing the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

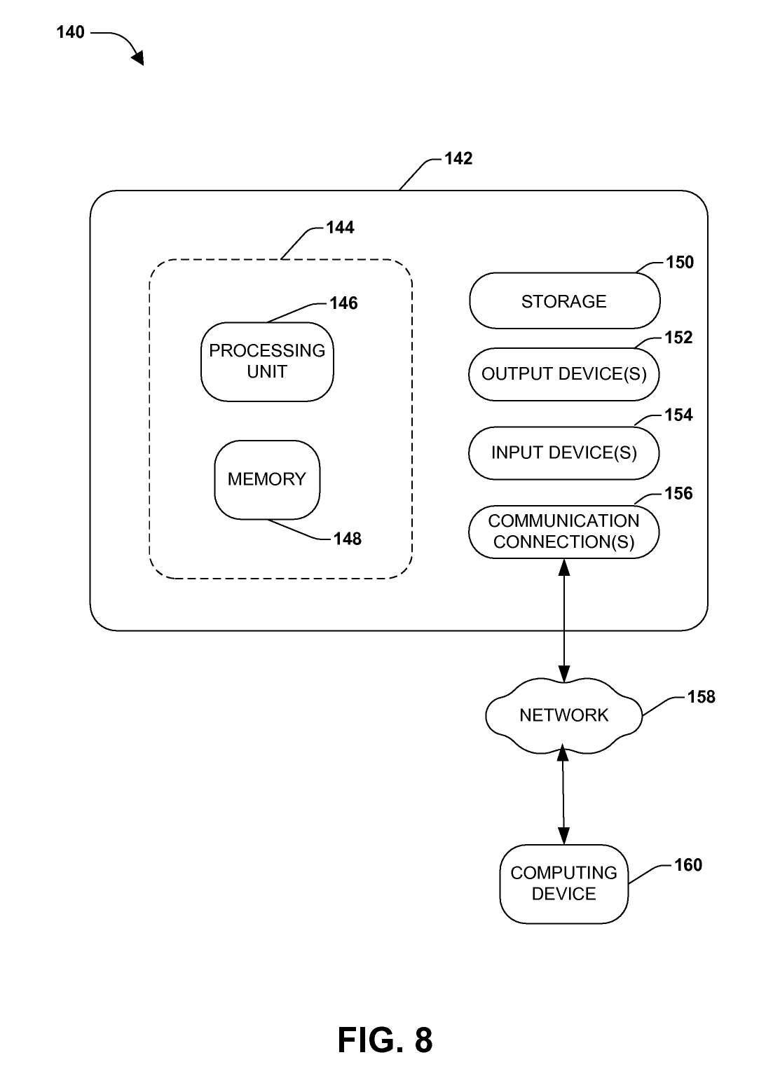

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 140 comprising a computing device 142 configured to implement one or more embodiments provided herein. In one configuration, computing device 142 includes at least one processing unit 146 and memory 148. Depending on the exact configuration and type of computing device, memory 148 may be volatile (such as RAM, for example), non-volatile (such as ROM, flash memory, etc., for example) or some combination of the two. This configuration is illustrated in FIG. 8 by dashed line 144.

In other embodiments, device 142 may include additional features and/or functionality. For example, device 142 may also include additional storage (e.g., removable and/or non-removable) including, but not limited to, magnetic storage, optical storage, and the like. Such additional storage is illustrated in FIG. 8 by storage 150. In one embodiment, computer readable instructions to implement one or more embodiments provided herein may be in storage 150. Storage 150 may also store other computer readable instructions to implement an operating system, an application program, and the like. Computer readable instructions may be loaded in memory 148 for execution by processing unit 146, for example.

The term “computer readable media” as used herein includes computer storage media. Computer storage media includes volatile and nonvolatile, removable and non-removable media implemented in any method or technology for storage of information such as computer readable instructions or other data. Memory 148 and storage 150 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 142. Any such computer storage media may be part of device 142.

Device 142 may also include communication connection(s) 156 that allows device 142 to communicate with other devices. Communication connection(s) 156 may include, but is not limited to, a modem, a Network Interface Card (NIC), an integrated network interface, a radio frequency transmitter/receiver, an infrared port, a USB connection, or other interfaces for connecting computing device 142 to other computing devices. Communication connection(s) 156 may include a wired connection or a wireless connection. Communication connection(s) 156 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 142 may include input device(s) 154 such as keyboard, mouse, pen, voice input device, touch input device, infrared cameras, video input devices, and/or any other input device. Output device(s) 152 such as one or more displays, speakers, printers, and/or any other output device may also be included in device 142. Input device(s) 154 and output device(s) 152 may be connected to device 142 via a wired connection, wireless connection, or any combination thereof. In one embodiment, an input device or an output device from another computing device may be used as input device(s) 154 or output device(s) 152 for computing device 142.

Components of computing device 142 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 142 may be interconnected by a network. For example, memory 148 may be comprised of multiple physical memory units located in different physical locations interconnected by a network.

Those skilled in the art will realize that storage devices utilized to store computer readable instructions may be distributed across a network. For example, a computing device 160 accessible via network 158 may store computer readable instructions to implement one or more embodiments provided herein. Computing device 142 may access computing device 160 and download a part or all of the computer readable instructions for execution. Alternatively, computing device 142 may download pieces of the computer readable instructions, as needed, or some instructions may be executed at computing device 142 and some at computing device 160.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of representing trustworthiness of an entity, comprising: representing the trustworthiness of the entity as a trust profile comprising at least one trust record, respective trust records generated by a trust record source and representing a relationship of the entity with the trust record source, generated in response to a relationship assertion received from the entity and specifying the trust record source, the trust profile comprising:
the trust record source;
at least one relationship descriptor describing the nature of the relationship of the entity with the relationship source; and
at least one relationship rating describing the quality of the relationship according to the relationship source.

2. The method of claim 1, at least one relationship descriptor representing a relationship category comprising at least one of:
a commercial relationship;
a professional relationship;
an academic relationship;
a special interest relationship;
a social network relationship;
a community relationship; and
a volunteer relationship.

3. The method of claim 1:
respective trust record sources comprising organizations, and
respective relationships comprising a membership of the entity with an organization.

4. The method of claim 3, at least one organization comprising an internet-based community.

5. The method of claim 1, at least one relationship descriptor representing at least one of:
the duration of the relationship;
the contribution of the entity to the relationship;
at least one transaction event relating to the relationship; and
at least one activity of the entity relating to the relationship.

6. The method of claim 5, the relationship ratings relating to respective relationship descriptors describing the relationship of the entity with the relationship source.

7. The method of claim 1, the trust record comprising at least one of:
at least one aggregated relationship rating associated with a trust record and describing the quality of the relationship according to the trust record source; and
an aggregated trust rating associated with at least two trust records and describing the quality of at least two relationships of the entity with at least two trust record sources.

8. A method of representing trustworthiness of an entity, comprising:
upon receiving from the entity a request to generate a trust profile, generating a trust profile;
upon receiving from the entity a relationship assertion specifying a trust record source, requesting a trust record of the entity from the trust record source;
upon receiving the trust record from the trust record source, storing the trust record in the trust profile of the entity; and
upon receiving a request for the trust profile of the entity, providing the trust profile.

9. The method of claim 8, the trust record comprising:
at least one trust record source having a relationship with the entity;
at least one relationship descriptor describing the nature of the relationship of the entity with the relationship source; and
at least one relationship rating describing the quality of the relationship according to the relationship source.

10. The method of claim 8, comprising:
upon receiving the request to generate the trust profile:
requesting from the entity at least one entity credential authenticating the identity of the entity, and
upon receiving the at least one entity credential, authenticating the identity of the entity according to the at least one entity credential.

11. The method of claim 8, comprising:
upon receiving the relationship assertion:
requesting from the entity at least one relationship credential authenticating the relationship of the entity with the trust record source; and
upon receiving the at least one relationship credential, authenticating the relationship of the entity with the trust record source according to the at least one relationship credential.

12. The method of claim 8, comprising:
upon receiving the relationship assertion:
searching a trust record source dataset for the trust record source specified in the relationship assertion; and
upon finding the trust record source in the trust record source dataset:
retrieving from the trust record source dataset a trust record requesting protocol associated with the trust record source, and
requesting the trust record of the entity from the trust record source according to the trust record requesting protocol.

13. The method of claim 12, comprising:
upon failing to find the trust record source in the trust record source dataset:
authenticating the trust record source;
requesting from the trust record source a trust record requesting protocol; and
upon receiving the trust record requesting protocol from the trust record source:
storing the trust record source in the trust record source dataset;
storing the trust profile requesting protocol in the trust record source dataset; and
requesting the trust record of the entity from the trust record source according to the trust record requesting protocol.

14. The method of claim 13, comprising:
upon failing to receive a trust record requesting protocol from the trust record source:
generating a trust record source protocol petition, and
adding the entity to the trust record source protocol petition;
upon receiving a relationship assertion from at least one additional entity, adding the at least one additional entity to the trust record source protocol petition; and
sending the trust record requesting petition to the trust record source.

15. The method of claim 8, comprising:
upon receiving a request for the trust profile of the entity by a requester, providing a trust profile of the entity comprising trust records stored in the trust profile of the entity.

16. The method of claim 15, the trust profile comprising:
at least one identifier of the entity; and
at least a portion of at least one trust record for respective trust record sources.

17. The method of claim 16, the trust profile comprising at least one of:
at least one aggregated relationship rating associated with a trust record and describing the aggregated quality of the relationship according to the trust record source; and
an aggregated trust rating associated with at least two trust records and describing the aggregated quality of at least two relationships of the entity with at least two trust record sources.

18. The method of claim 15:
the request specifying a requester, and
the trust profile of the entity comprising viewable portions of viewable trust records according to viewing permissions of the requester.

19. The method of claim 15, comprising:
before providing the trust profile to the requester:
requesting at least one requester credential authenticating the identity of the requester; and
upon receiving the at least one requester credential from the requester, authenticating the identity of the requester according to the at least one requester credential.

20. The method of claim 8, comprising:
periodically requesting an updated trust record representing the relationship with the entity from respective trust record sources; and
upon receiving the updated trust record, storing the updated trust record in the trust profile of the entity.

21. The method of claim 8, comprising:
upon receiving from the entity a removal request of a trust record from the trust profile, removing the trust record from the trust profile.

22. A system configured to represent trustworthiness of an entity, comprising:
a trust profile store configured to store trust records comprising a trust profile of the entity;
a trust profile generating component configured, upon receiving from the entity a request to generate the trust profile, to generate the trust profile in the trust profile store;
a trust profile compiling component configured to:
upon receiving from the entity a relationship assertion specifying a trust record source, request a trust record of the entity from the trust record source; and
upon receiving the trust record from the trust record source, store the trust record with the trust profile in the trust profile store; and
a trust reporting component configured, upon receiving a request for the trust profile of the entity, to provide the trust profile.

23. The system of claim 22, comprising:
a trust record source dataset representing a set of trust record sources, respective trust record sources associated with at least one trust record requesting protocol; and
the trust profile compiling component configured to request the trust record by:
searching the trust record source dataset for the trust record source specified in the relationship assertion; and
upon finding the trust record source in the trust record source dataset:
retrieving from the trust record source dataset a trust record requesting protocol associated with the trust record source, and
requesting the trust record of the entity from the trust record source according to the trust record requesting protocol.

24. The system of claim 23, the trust profile compiling component configured to:
upon failing to find the trust record source in the trust record source dataset:
authenticate the trust record source;
request from the trust record source a trust record requesting protocol; and
upon receiving the trust record requesting protocol from the trust record source:
store the trust record source in the trust record source dataset;
store the trust profile requesting protocol in the trust record source dataset; and
request the trust record of the entity from the trust record source according to the trust record requesting protocol.

25. The system of claim 22, the trust reporting component configured, upon receiving a request for the trust profile of the entity by a requester, to provide a trust profile of the entity comprising trust records stored in the trust profile of the entity, the trust profile comprising:
at least one identifier of the entity;
at least a portion of at least one trust record for respective trust record sources; and
at least one of:
at least one aggregated relationship rating associated with a trust record and describing the aggregated quality of the relationship according to the trust record source, and
an aggregated trust rating associated with at least two trust records and describing the aggregated quality of at least two relationships of the entity with at least two trust record sources.
